(19) United States
(12) Patent Application Publication
(10) Pub. No.: US 2010/0114431 A1
(43) Pub. Date: May 6, 2010

(54) Method for Controlling Vehicle Dynamics

(75) Inventors: Joshua Switkes, Menlo Park, CA (US); Arne Stoschek, Palo Alto, CA (US)

Correspondence Address: MANFRED BECK PA, PO BOX 431255, SOUTH MIAMI, FL, 33243-1255, US

(73) Assignee: VOLKSWAGEN GROUP OF AMERICA, INC., Auburn Hills, MI (US)

(21) Appl. No.: 12/262,702

(22) Filed: Oct. 31, 2008

(51) Int. Cl. B62D 6/00

(52) U.S. Cl. 701/41

(57) ABSTRACT

A method for controlling vehicle dynamics includes acquiring steering torque data indicative of forces acting on at least one tire of a vehicle and acquiring image data by capturing images of an area outside the vehicle. The friction coefficient between a tire of the vehicle and a road surface is determined as a function of vehicle data including at least the steering torque data. The lateral velocity of the vehicle is determined as a function of vehicle data including the steering torque data and/or the image data. A vehicle dynamics control is performed as a function of the lateral velocity and the friction coefficient.

### FIELD OF THE INVENTION

The invention relates to a method for controlling vehicle dynamics, wherein vehicle data are ascertained and a vehicle dynamics control is performed based on the vehicle data.

### BACKGROUND OF THE INVENTION

Vehicle dynamics control systems are generally developed for the purpose of improving safety and driving comfort. These systems are for example designed to detect and prevent skids, to prevent an unintended lane departure of the vehicle or to prevent an excessive roll motion of the vehicle.

Control of a vehicle in emergency situations requires knowledge of a number of variables that define the vehicle state. One of the variables defining the vehicle state is the current friction coefficient between the tires of the vehicle and the road surface. Another variable defining the vehicle state is the current motion of the vehicle. If current values for the friction coefficient between the vehicle tires and the road surface and current values for the motion of the vehicle are not known or if current values defining the vehicle state are only crudely approximated, then vehicle dynamics control systems need to be tuned conservatively taking into account that the variables defining the vehicle state may be inaccurate. As a result, vehicle dynamics control systems may engage too early and they may not respond appropriately in certain situations.

A rotation rate sensor for measuring a rotation of the vehicle about its vertical axis and a lateral accelerometer for measuring an acceleration of the vehicle in a lateral direction can be used in order to estimate the motion of the vehicle. A complete description of the motion of the vehicle for the purposes of a vehicle dynamics control system must include the rotation rate of the vehicle about its vertical axis and the lateral velocity of the vehicle. The lateral velocity is usually calculated by integrating acceleration values, which often results in inaccurate values for the lateral velocity of the vehicle. Measuring rotation rates of the vehicle and lateral accelerations of the vehicle may therefore be insufficient for providing accurate lateral velocity estimates for all dynamic conditions. Specific cases, in which the measurements performed by rotation rate sensors and lateral accelerometers are inadequate, include for example long, slow turns and banked roads. Conventional vehicle dynamics control systems in production vehicles therefore use various heuristics to combat these types of situations. In addition, vehicle dynamics control systems in production vehicles are tuned conservatively, i.e. they engage early, in order to avoid the above described problems associated with inaccurate estimates for the vehicle motion.

In order to increase the accuracy and reliability of calculating the motion of the vehicle, it is desirable to have sufficiently accurate variables defining the vehicle state. It is in particular desirable to have an accurate estimate for the friction coefficient between the tires and the road surface. Some vehicle dynamics control systems provide a crude estimate for the friction coefficient by using rain sensors or thermometers in order to guess whether there might be water or ice on the ground which would lower the friction level. These estimates for the friction coefficient are inaccurate because the friction level also depends on the tires, the type of road, the amount of water on the road, and other factors. Without an accurate estimate for the friction coefficient, even the vehicle dynamics control system that use rain sensors or thermometers must be tuned conservatively and they don't respond as precisely as would be desirable.

Furthermore, there is research in the field of vehicle dynamics control systems that use external sensors such as GPS (Global Positioning System) sensors or optical sensors in order to measure and/or estimate velocities and accelerations. A GPS receiver can provide highly accurate vehicle velocity and heading information which can be used to calculate the lateral velocity of the vehicle. Alternatively, an optical sensor may be installed that looks at the surface of the road or ground and determines a lateral and a longitudinal velocity of the vehicle, in a manner similar to the process used in an optical computer mouse.

A disadvantage of using GPS in production cars is the cost associated with the installation of a GPS system. A further disadvantage of using a GPS system is that it is subject to outages when the view of the sky is blocked, such as in a tunnel or under dense tree cover. A disadvantage of the above-mentioned downward-looking optical sensors is that they can get fouled by road dirt. Another problem of optical sensors is that they may suffer from measurement errors caused by road irregularities or errors caused by vehicle suspension movements.

Vehicle dynamics control systems that determine the motion of the vehicle without the above described direct measurement methods using GPS sensors or optical sensors, mostly determine the rate of change of the lateral velocity and also determine the rotation rate of the vehicle for a rotation about a vertical vehicle axis. These vehicle dynamics control systems compare the values for the rate of change of the lateral velocity and the rotation rate to an estimate of the driver's intention based on a steering angle. The lateral velocity is in this case estimated as a function of the rate of change of the lateral velocity. A disadvantage of estimating the lateral velocity in this manner is that the estimation process provides only a crude approximation of the lateral velocity. The vehicle dynamics control system must therefore be tuned such that it intervenes earlier than necessary for preventing vehicle instability.

In order to determine the friction coefficient between the tires of a vehicle and the road surface, it is further known from U.S. Pat. No. 6,556,911 B2 to set a road friction coefficient based on the relationship between a detected self-aligning torque and a detected steered wheel slip angle. U.S. Pat. No. 6,898,966 B2 also discloses estimating a road friction coefficient based on the relationship between a self-aligning torque applied to a tire and a slip angle of a tire.

A further method of using steering torque for estimating a friction coefficient is described by Yung-Hsiang Judy Hsu, Shad Laws, Christopher D. Gadda and J. Christian Gerdes in the article “A method to estimate the friction coefficient and tire slip angle using steering torque tire parameters,” Proceedings of the 2006 ASME International Mechanical Engineering Congress and Exposition (IMECE). Another method for estimating vehicle sideslip by using steering torque information is described by Paul Yih, Jihan Ryu and J. Christian Gerdes in the article “Vehicle state estimation using steering torque,” American Control Conference, 2004.

Further methods for estimating a friction coefficient between a tire and a road surface are for example disclosed in U.S. Pat. No. 7,398,145 B2 and U.S. Pat. No. 6,662,898 B1. Also known are methods for measuring forces acting on a tire by integrating sensors in the tire such as described in U.S. Pat. No. 7,203,603 B2. Further known are camera-based lane recognition systems such as the system described in U.S. Pat. No. 7,295,682 B2. The use of a camera for determining a lateral velocity of a vehicle is for example described in U.S. Pat. No. 7,197,388 B2.

### SUMMARY OF THE INVENTION

It is accordingly an object of the invention to provide a method for controlling vehicle dynamics which improves accuracy and reliability of prior art methods and which can be implemented in a cost-efficient manner in production vehicles.

With the foregoing and other objects in view there is provided, in accordance with the invention, a method for controlling vehicle dynamics, which includes the steps of:

acquiring steering torque data indicative of forces acting on at least one tire of a vehicle;

acquiring image data by capturing images of an area outside the vehicle;

determining a friction coefficient between at least one tire of the vehicle and a road surface as a function of vehicle data including at least the steering torque data;

determining a lateral velocity of the vehicle as a function of vehicle data including at least one of the steering torque data and the image data; and

performing a vehicle dynamics control as a function of at least the lateral velocity and the friction coefficient.

An advantage of determining the friction coefficient as a function of steering torque data and determining the lateral velocity as a function of steering torque data and/or image data is that the performance of the vehicle dynamics control is improved because an increased accuracy of the values for the lateral velocity and the friction coefficient results in an increase in the precision of the control responses of the vehicle dynamics control system.

Another advantage of the method according to the invention is that its implementation usually requires only a minimal hardware outlay in modern production vehicle that already have a steering torque sensor, a camera and a yaw sensor installed. A further advantage of the method of the invention is that the lateral velocity can be determined from the steering torque data as well as from the image data, which increases accuracy and also reliability.

A further mode of the method according to the invention includes acquiring the image data with a vehicle-mounted camera by capturing images of a road; performing an image processing in order to detect lane markers provided on the road; and determining the lateral velocity of the vehicle by evaluating a motion of the vehicle with respect to the lane markers. This feature is advantageous for vehicles that are equipped with a lane-keeping system that has a camera and a processor for detecting lane markers. The image data for determining the lateral velocity can in this case be acquired with the hardware that is already provided for the lane-keeping system.

Another mode of the method according to the invention includes determining a lateral error of the vehicle by evaluating a motion of the vehicle with respect to the lane markers, wherein the lateral error is a distance between an imaginary lane centerline and a center of gravity of the vehicle; determining a heading error of the vehicle by evaluating the motion of the vehicle with respect to the lane markers, wherein the heading error is a difference in angle between the imaginary lane centerline and a direction of a longitudinal axis of the vehicle; determining a longitudinal velocity of the vehicle; and determining the lateral velocity of the vehicle as a function of the lateral error, the heading error and the longitudinal velocity the vehicle.

Yet another mode of the method according to the invention includes determining at least the lateral velocity of the vehicle with an optic flow technique by examining an apparent movement of objects in images captured by a camera and by calculating a motion of the vehicle as a function of the apparent movement of the objects in the images.

Another mode of the method according to the invention includes using a vehicle-mounted rear-view camera in order to capture the images of the area outside the vehicle. As a result, no additional camera needs to be installed if the vehicle already has a rear-view camera.

A further mode of the method according to the invention includes acquiring the steering torque data by measuring a torque with a torque sensor mounted in a steering column of the vehicle. The measured torque is in this case a combination of a torque created by forces acting on the tires, the torque of the power steering assist and the torque applied by the driver when turning the steering wheel.

Another mode of the method according to the invention includes acquiring the steering torque data from torque measurements performed by a sensor which measures a torque across a power steering unit of an electric power steering system or a drive-by-wire steering system.

Another mode of the method according to the invention includes acquiring the steering torque data by evaluating a torque provided by an electric motor powering an electric power steering system of the vehicle. Since the torque characteristic of the electric motor is known, the steering torque data can be acquired by evaluating the torque provided by the electric motor.

A further mode of the method according to the invention includes acquiring the steering torque data by measuring a force in a steering tie-rod of a steering system of the vehicle. In this case, steering torque data and forces acting on the tires can be calculated because the suspension geometry is known.

Another mode of the method according to the invention includes acquiring the steering torque data by measuring, with a sensor integrated in a tire of the vehicle, a force acting on the tire of the vehicle.

Another mode of the method according to the invention includes determining a body sideslip angle of the vehicle; performing a vehicle dynamics control by engaging a vehicle dynamics control system, if the lateral velocity and/or the body sideslip angle exceeds a respective threshold value; and controlling, with the vehicle dynamics control system, at least one vehicle system such as a brake system, a steering system, an engine, a transmission and/or a suspension system.

Yet another mode of the method according to the invention includes determining wheel slip angles as a function of the lateral velocity of the vehicle, a longitudinal velocity of the vehicle, a distance between a center of gravity of the vehicle and a front axle of the vehicle, a distance between the center of gravity of the vehicle and a rear axle of the vehicle, a yaw rate and a steering angle; performing a vehicle dynamics control by engaging a vehicle dynamics control system, if at least one of the wheel slip angles exceeds a respective threshold value; and controlling, with the vehicle dynamics control system, at least one vehicle system such as a brake system, a steering system, an engine, a transmission and/or a suspension system.

Another mode of the method according to the invention includes monitoring the friction coefficient and performing a vehicle dynamics control by engaging a vehicle dynamics control system, if the friction coefficient falls below a given threshold value; and controlling, with the vehicle dynamics control system, at least one vehicle system such as a brake system, a steering system, an engine, a transmission and/or a suspension system.

A further mode of the method according to the invention includes determining a wheel slip angle of a front wheel of the vehicle; and performing a vehicle dynamics control by controlling a steering system of the vehicle such that a torque assist for a steering wheel of the vehicle is decreased, if the wheel slip angle of the front wheel exceeds a given threshold value. By reducing the torque assist or power assist, it becomes more difficult for the driver to turn the steering wheel. This increases the likelihood that the driver reduces excessive steering movements. As a result, wheel slip angles may be reduced and vehicle stability may be improved.

Another mode of the method according to the invention includes controlling a steering system of the vehicle such that a torque assist for a steering wheel of the vehicle is decreased, if the friction coefficient falls below a given threshold value. In case of slippery road conditions it is advantageous to reduce the torque assist or power assist for the steering. The driver gets more feedback through the steering wheel and reduces excessive steering movements.

Another mode of the method according to the invention includes determining a wheel slip angle of a rear wheel of the vehicle; and performing a vehicle dynamics control by controlling an active steering system of the vehicle such that a steering angle of a front wheel is increased, if the wheel slip angle of the rear wheel exceeds a given threshold value. This allows saturating the front wheels when it is detected that the rear wheels saturate. As a result, the net yaw moment of the vehicle is reduced.

Another mode of the method according to the invention includes determining a wheel slip angle of a rear wheel of the vehicle; and performing a vehicle dynamics control by controlling an active steering system of the vehicle such that a steering angle of a front wheel is increased, if the wheel slip angle of the rear wheel exceeds a given threshold value and the friction coefficient falls below a given threshold value. As mentioned above, this allows saturating the front wheels when the rear wheels saturate. The net yaw moment of the vehicle is reduced and an impending spinning or instability of the vehicle can be prevented.

Another mode of the method according to the invention includes acquiring inertial sensor data indicative of a motion of the vehicle; and determining the lateral velocity of the vehicle as a function of vehicle data including at least the inertial sensor data. By providing different types of data, namely inertial sensor data, steering torque data and image data for determining the lateral velocity, the reliability and the accuracy of the vehicle dynamics control system can be increased.

Although the invention is illustrated and described herein as embodied in a method for controlling vehicle dynamics, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagram of a planar single-track model for illustrating coordinates, velocities and angles related to vehicle dynamics;

FIG. 2 is a top plan view of a vehicle on a road for illustrating coordinates and angles related to vehicle dynamics;

FIG. 3 is a block diagram of a simplified exemplary embodiment of a vehicle dynamics control system in accordance with the invention; and

FIG. 4 is a block diagram illustrating components of an exemplary embodiment of a vehicle dynamics control system in accordance with the invention.

### DESCRIPTION OF THE PREFERRED EMBODIMENTS

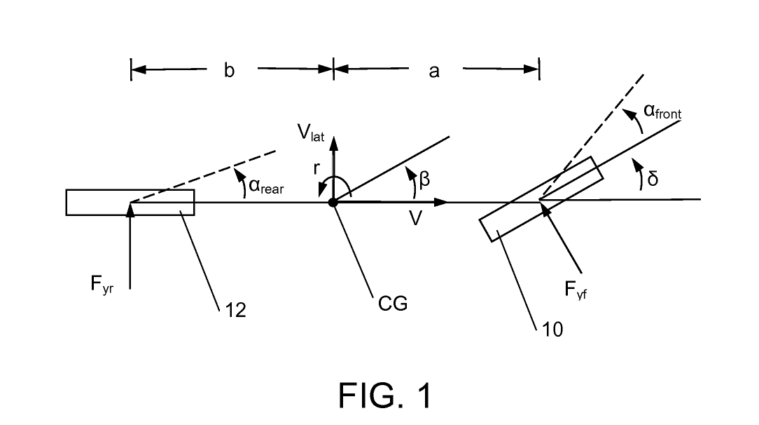

Referring now to the figures of the drawings in detail and first, particularly, to FIG. 1 thereof, there is shown a diagram of a planar single-track model for illustrating the coordinates, velocities and angles that are used when describing vehicle dynamics. The single-track vehicle model shown in FIG. 1 groups the left front tire and the right front tire of the vehicle into a front tire 10. The left rear tire and the right rear tire of the vehicle are grouped into a rear tire 12. F_{yr} and F_{yf} are lateral tire forces, i.e. the resultant forces on the front tire 10 and the rear tire 12. The wheel slip angle of the rear tire 12 is denoted by αᵣₑₐᵣ. The wheel slip angle of the front tire 10 is denoted by α_{front}. The wheel slip angle α is the angle between the orientation of the tire and the velocity vector of the tire. The distance between the center of gravity CG of the vehicle and the front axle of the vehicle is indicated by a distance a. The distance between the center of gravity CG of the vehicle and the rear axle of the vehicle is indicated by a distance b. The vehicle velocity is indicated by a longitudinal velocity V and a lateral velocity Vₗₐₜ. The rotation of the vehicle about its vertical axis is indicated by a yaw rate r. The body sideslip angle β is the angular difference between the direction of the longitudinal axis of the vehicle and the movement direction of the center of gravity CG of the vehicle.

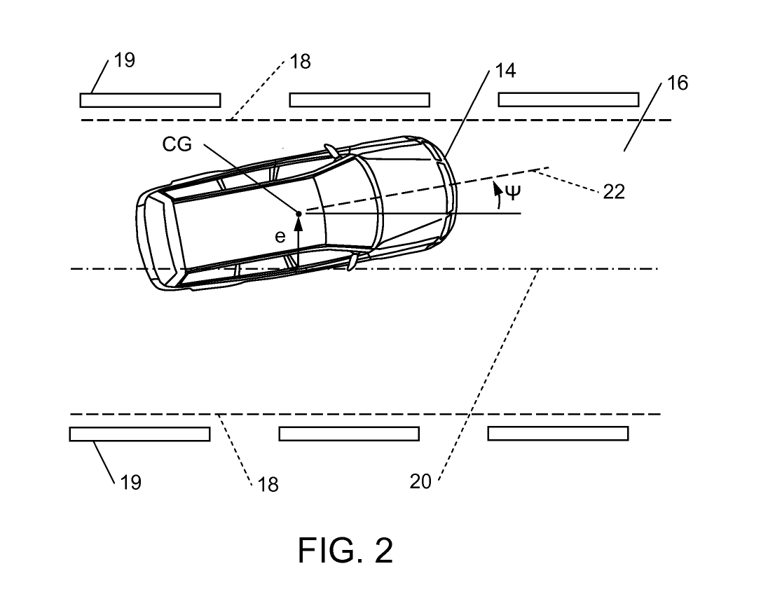

FIG. 2 is a top plan view of a vehicle 14 on a road for illustrating coordinates and angles related to vehicle dynamics. The vehicle 14 drives on a lane 16 which has imaginary boundaries indicated by dashed lines 18. Lane markers 19 are painted on the road. The lane centerline 20, which is also an imaginary line, is indicated by a dash-dotted line 20. The lateral error e is the distance between the lane centerline 20 and the center of gravity CG of the vehicle 14. The heading error Ψ is the difference in angle between the lane centerline 20 and the direction of the longitudinal axis 22 of the vehicle 14.

In order to perform an improved vehicle dynamics control in accordance with the invention, it is necessary to determine the friction coefficient μ between the tires of the vehicle 14 and the road surface and to determine the lateral velocity Vₗₐₜ of the vehicle 14 in a reliable and accurate manner.

In accordance with a first mode of sensing the lateral velocity Vₗₐₜ of the vehicle 14, visual information captured by at least one camera 44 is used to determine the lateral velocity Vₗₐₜ of the vehicle 14. The visual information for determining the lateral velocity Vₗₐₜ may be captured by a camera 44 that is already installed in the vehicle 14 for other purposes, such as a camera for a lane departure warning system or a heading control system. Thus hardware outlay and production costs can be reduced. Production vehicles increasingly have cameras looking forward from the vehicle to detect the lane markers or lane lines 19 on the road. The lane markers 19 are detected by the lane departure warning system or the heading control system with the camera provided for that purpose.

The lateral velocity Vₗₐₜ of the vehicle 14 can be calculated based on the detection of lane markers 19 that are provided on the road. In this case, just like in case of a lane departure warning or a lane-keeping assistance system, a forward facing camera 44 is used to detect the lane that the vehicle is driving in. Such a lane departure warning system or lane-keeping assistance system provides information about a relative lane position, i.e. the position of the vehicle 14 with respect to the lane 16 the vehicle 14 is driving in. The relative lane position is expressed by the lateral error e, which is the distance between the lane centerline 20 and the center of gravity CG of the vehicle 14.

The detection of the lane markers 19 relies on image processing, i.e. the image is processed to extract the lane markers 19 from the image. The lane markers 19 are typically white or yellow dashed lane markers or solid lane markers of various widths that are painted on the road. U.S. Pat. No. 7,295,682 B2 describes an exemplary embodiment of a road recognition system.

In accordance with the invention, visual information provided by a camera 44 is evaluated using the following equation:

Vₗₐₜ=ė−ψV (1)

In equation (1), Vₗₐₜ denotes the lateral velocity, ė is the time derivation of the lateral error e, ψ is the heading error, and V is the longitudinal velocity of the vehicle 14 as illustrated in FIG. 1 and FIG. 2.

The longitudinal velocity V or speed of the vehicle 14 can be ascertained with sufficient accuracy by using the wheel speed sensors 48 of the vehicle 14. The time derivation of the lateral error ė and the heading error ψ can be determined by using an image processing of the visual information provided by the camera 44.

In accordance with another mode, a so-called optic flow technique is used to determine the motion of the vehicle 14. An optic flow technique examines the apparent movement of objects in the image that is captured by the camera 44 and calculates the movement of the vehicle 14 from the apparent movement of the objects in the image. In case of a general object whose motion is to be determined, the unknown velocities would normally be the lateral, longitudinal and vertical velocities of the vehicle 14, and the three rotation rates about a lateral axis, a longitudinal axis and a vertical axis of the vehicle 14. In case of a vehicle as an object whose motion is to be determined, it can be assumed that the pitch rate of the vehicle is fairly small and that the vertical velocity of the vehicle is also very small. The longitudinal velocity V of the vehicle is determined with sufficient accuracy by wheel speed sensors 48. The yaw rate r of the vehicle can be determined with sufficient accuracy by a yaw gyro or any other inertial sensor 46 that can be used to measure a yaw motion, such as an acceleration sensor. A yaw motion is a rotation about a vertical vehicle axis, a roll motion is a rotation about a longitudinal vehicle axis, and a pitch motion is a rotation about a transverse vehicle axis.

As mentioned above, a vehicle dynamics control system must determine the current motion of the vehicle in order to be able to control the vehicle. In the case of a vehicle whose pitch rate and whose vertical velocity are assumed to be negligibly small, the unknown quantities are the lateral velocity Vₗₐₜ and the roll rate. Through the use of a roll rate sensor, which may be provided in the vehicle for rollover protection, the roll rate can be measured. The problem of determining the motion of the vehicle is thus simplified to a single unknown quantity, namely the lateral velocity Vₗₐₜ, which can be determined directly from the optic flow by using a conventional optical flow technique.

In accordance with an embodiment of the invention, a rear-view camera of the vehicle is used for the above-described detection of lane markers 19 and/or for optical flow techniques. Many vehicles are equipped with a rear-view camera to aid in backing-up maneuvers. Hardware outlay for a system according to the invention is minimized if a camera that is already installed for other purposes is used for detecting the lateral velocity Vₗₐₜ of the vehicle.

In addition to determining the motion of the vehicle for performing a vehicle dynamics control in emergency situations, it is also necessary to determine the friction coefficient μ between the tires 10, 12 of the vehicle 14 and the road surface. By increasing the accuracy of the determination of the vehicle motion and the friction coefficient μ, it is possible to improve the response of the vehicle dynamics control system in emergency situations. The friction coefficient μ can for example be determined from a steering torque or aligning torque which acts on the front tires such that it opposes the steering and causes the steering wheel of a conventional steering system to return to its center position. The aligning torque can for example be determined by measuring a steering torque in the steering column of the vehicle. Methods for determining the friction coefficient μ between the tires and the road surface by measuring an aligning torque or a steering torque are known in the prior art, such as the methods described in U.S. Pat. No. 6,898,966 B2.

The steering torque is understood as a torque that is directly related to forces acting in the steering system, including forces acting on the front tires, such as forces related to an aligning torque, forces related to the inertia and damping of the steering system, forces related to friction, the steering ratio, and the torque magnification of the power steering. The forces acting on the tires results from the friction between the tires and the road surface, and are a function of the vehicle motion including the lateral velocity Vₗₐₜ. Thus once the aligning torque is known, wherein the aligning torque results from a lateral tire force acting at a distance (trail) from the steering axis of a wheel, the lateral velocity Vₗₐₜ and the friction coefficient μ can be estimated.

The calculation of the aligning torque can be based on measurement values provided by a steering torque sensor 40 measuring a torque in the steering column. Utilizing the steering torque is advantageous because steering torque measurements are readily available in vehicles having an electric power steering system or a steer-by-wire system. The aligning torque, which depends on the total trail and the lateral tire forces, can be calculated from the measured steering torque values. Thus, ultimately the lateral velocity can be calculated from the measured steering torque values.

The torque that is for example measured by the torque sensor in the steering column is a combination of the torque resulting from road forces, the torque from the power steering assist, and the torque from the driver. The torque that is supplied by the power steering assist can be determined based on known operating characteristics of the power steering system. In case of a slow driving maneuver, the driver torque, i.e. the torque applied by a driver to the steering column, is approximately equal to the counteracting combined torque from the road forces and the power steering. The road torque, i.e. the torque resulting from the road forces, can thus be calculated.

If the power steering system is an electric power steering system rather than a hydraulic system, the aligning torque can be determined by evaluating sensor information or by evaluating the motor torque of the electric motor driving the electric power steering system. As described above, the aligning torque is used to calculate the friction coefficient μ between the tires and the road surface. An electric power steering system itself provides two sources of information about the torque acting on the steering column. First, the electric power steering system contains a sensor which directly measures the torque applied across the power steering unit. Second, the torque applied by the electric motor itself can be used as a measurement value for the torque across the power steering unit.

In accordance with a further method for sensing a steering torque, a force sensor is provided in the steering tie-rod of the steering system 56 of the vehicle. The steering tie-rod is a laterally extending arm connecting the steering box to the wheel hub. The force sensor is for example a conventional load cell that converts a force acting on the steering tie-rod and on the load cell into an electrical signal. Since the suspension geometry of the vehicle is known, it is possible to calculate a steering torque and a tire side force as a function of the force measured by the force sensor placed in the steering tie-rod.

Another method of sensing a steering torque or a side force acting on the tire includes integrating sensors in the tire. Tires having a built-in sensing capability may be used in order to determine a side force acting on a tire.

In accordance with the method of the invention, any of the above described methods can be used to measure or calculate a steering torque or side forces acting on the tires. The lateral velocity Vₗₐₜ and the friction coefficient μ between the tires and the road can therefore be determined with one or more of the methods described above. Since the lateral velocity Vₗₐₜ and the friction coefficient μ can be determined with an improved accuracy, the vehicle dynamics control is also improved because the operation of the vehicle dynamics control relies on more accurate values for the lateral velocity Vₗₐₜ and the friction coefficient μ. More specifically, the information about the lateral velocity Vₗₐₜ and the friction coefficient μ is used to determine when to engage the vehicle dynamics control system. In other words, the lateral velocity Vₗₐₜ and the friction coefficient μ are used to determine when a countermeasure for preventing vehicle instability is to be triggered.

Countermeasures to prevent vehicle instability are preferably triggered in accordance with the following criteria. A countermeasure to prevent or reduce vehicle instability is triggered when the lateral velocity Vₗₐₜ exceeds a given threshold value. A countermeasure to prevent or reduce vehicle instability can also be triggered if the body sideslip angle β exceeds a given threshold. A large body sideslip angle β is an indication that the vehicle may soon reach instability or may already have reached a point of instability. The body sideslip angle β is generally defined as the angular difference between the direction of the longitudinal axis of the vehicle and the movement direction of the center of gravity CG of the vehicle. The body sideslip angle β can be expressed as a function of the lateral velocity Vₗₐₜ and the longitudinal velocity V in the following manner:

$$β = arctan ( \frac{{V}_{lat}}{V} ) \qquad ( 2 )$$

Measures for countering vehicle instability can furthermore be triggered when a wheel slip angle α exceeds a given threshold value. Similar to the body sideslip angle β, the wheel slip angle α is defined as the angular difference between the direction the wheel is pointing and the direction the wheel is moving, as illustrated in FIG. 1. The wheel slip angle α_{front} for the front wheels and the wheel slip angle αᵣₑₐᵣ for the rear wheels can be expressed as a function of the lateral velocity of the vehicle Vₗₐₜ, the longitudinal velocity V, the distance a between the center of gravity CG of the vehicle and the front axle, the distance b between the center of gravity CG of the vehicle and the rear axle, the yaw rate r and the steering angle δ.

$$\begin{matrix}{α}_{front} = arctan ( \frac{{V}_{lat} + ar}{V} ) - δ & ( 3 ) \\ {α}_{rear} = arctan ( \frac{{V}_{lat} + br}{V} ) & ( 4 )\end{matrix}$$

As the wheel slip angles α_{front} and/or αᵣₑₐᵣ increase from zero to small angles, the lateral forces F_{yf} and F_{yr} acting on the tires increase in a substantially linear manner with the wheel slip angle α. As the wheel slip angles α increase to larger angles, the tires reach a saturation region which means that the lateral forces F_{yf} and F_{yr} acting on the tire reach a saturation limit and the tires begin to slide. Thus a countermeasure is needed to prevent the tires from sliding or limit the sliding of the tires.

Countermeasures for preventing or reducing vehicle instabilities can also be triggered based on the friction coefficient μ between the tires and the road surface. As the friction coefficient μ decreases, the likelihood of vehicle instability, such as sliding tires, increases and the likelihood that the driver loses control over the vehicle increases correspondingly. Thus countermeasures are triggered if the friction coefficient μ falls below a given threshold value.

The above-described criteria for triggering countermeasures can be combined in order to improve the performance of a vehicle stability control system. It is for example advantageous to trigger countermeasures based on a combination of friction coefficient information, wheel slip angle information and body sideslip angle information because a lower friction coefficient μ causes instabilities to occur at smaller slip angles. It is therefore expedient to reduce the threshold values for the wheel slip angles and body sideslip angles in case of a small friction coefficient. The vehicle stability control system will then engage at smaller wheels slip angles and body sideslip angles whenever the friction coefficient μ is low. Alternatively or additionally, the vehicle control system can increase the aggressiveness of countermeasures as the wheels slip angles and body sideslip angles increase and/or the friction coefficient μ decreases.

The above-mentioned countermeasures or reactions that are triggered by the vehicle stability control system for preventing, reducing or eliminating vehicle instability or loss of control are described in more detail in the following. The reactions or measures that are used to counter vehicle instability may include warnings for the driver and/or controlling the engine, the brakes, the steering system, the driven wheels or suspension components.

A simple countermeasure that may be used to avoid vehicle instability is a warning that makes the driver aware that a loss of control may occur due to for example slippery road conditions. The warning can be an audible alarm, a vibration in the steering wheel, in the pedals or in the seat, or can be a visual cue such as lights or text on a display.

A simple active countermeasure that directly affects the vehicle motion is controlling the engine 62 such that the output of the engine 62 is reduced or stopped entirely. The reduction of the engine output can be done by cutting off the fuel supply, by cutting spark, by closing the throttle, by retarding the ignition timing, by disengaging gears in the transmission or by changing the valve timing.

A further reaction in response to detecting that threshold conditions for the wheel slip angles α, the body sideslip angle β, and the friction coefficient μ have been met, is differential braking. In this case, the wheel brake pressure is selectively controlled for individual wheels of the vehicle. The vehicle dynamics control system 30 can thus apply a yaw moment to the vehicle 14 by applying a braking force to a single wheel. With the benefit of knowing the wheel slip angle α at each wheel and the friction coefficient μ, the available amount of force on each wheel can be calculated, which improves the selection of which wheel to brake. For example, if the rear wheels are near saturation but the front wheels are still in their linear operating region, then the vehicle stability control system can choose to apply braking to the front wheels.

Another countermeasure which may be used to prevent or reduce vehicle instability is controlling the power steering torque assist level. The vehicle stability control system 30 can adjust the power steering torque assist if the vehicle has an electric power steering system. For example, as the front wheels near saturation, which is identified by a combination of a large wheel slip angle α and a low friction coefficient μ, the torque assist for the steering wheel could decrease. In other words, the steering feel would change as the amount of torque assist provided by the power steering system is reduced.

In addition or as an alternative to controlling the torque assist as described above, the steering angle can be adjusted in order to avoid saturation of the front wheels. If the vehicle stability control system senses that the rear wheels are saturating, it could also increase the steering angle for the front wheels in order to saturate the front wheels. As a result, the net yaw moment on the vehicle could be reduced.

A further measure for preventing vehicle instability is the use of a differential drive. Similar to the way that differential braking can apply a yaw moment to the vehicle, a differential drive can be used to apply a yaw moment. The differential drive can be implemented by using an active differential of any type or by using individual electric hub motors driving individual wheels. Just as in the case of differential braking, the information about the wheel slip angle at each individual wheel allows the vehicle stability control system to determine the best wheel to which to apply additional torque. The amount of torque to be applied to the wheel is determined in dependence on the friction coefficient information.

Another measure for preventing vehicle instability, in particular for preventing a vehicle rollover, includes controlling active roll bars or other suspension components. The lateral velocity Vₗₐₜ and the friction coefficient μ between the tires and the road surface play a major role in rollover events in vehicles. Unless the vehicle tires are tripped by a curb or some other obstacle, it is for example difficult to have a vehicle rollover accident if the friction coefficient μ is small. A small friction coefficient μ means that the lateral forces acting on the tires are too small to generate the force that is necessary for a vehicle rollover. The estimation of the friction coefficient μ is therefore useful for vehicle stability control systems that provide a rollover prevention. Active roll bars, a fully active suspension, a semi-active suspension or other vehicle components can be controlled in order to avoid a vehicle rollover. Since a rollover event is less of a concern on a low friction surface, the vehicle stability control system can advantageously focus more on preventing vehicle instability rather than focusing on rollover prevention.

Conventional vehicle stability control methods that use only crude approximations for the lateral velocity Vₗₐₜ and the friction coefficient μ use accordingly inaccurate criteria for activating countermeasures. In contrast, the method according to the invention allows a more accurate activation of countermeasures against vehicle instability including rollovers, because the method relies on a more precise knowledge of the lateral velocity Vₗₐₜ and the friction coefficient μ. In particular, by increasing the accuracy of the values for the lateral velocity Vₗₐₜ and the friction coefficient μ it is possible to select a more suitable and effective countermeasure to an imminent vehicle instability. A further advantage of determining the lateral velocity Vₗₐₜ and the friction coefficient μ with an increased accuracy it that the vehicle stability control system can be configured such that it triggers countermeasures not earlier or more often than really necessary. As a result, the vehicle stability control system is perceived as less intrusive by drivers and driver acceptance of the vehicle stability control system is improved.

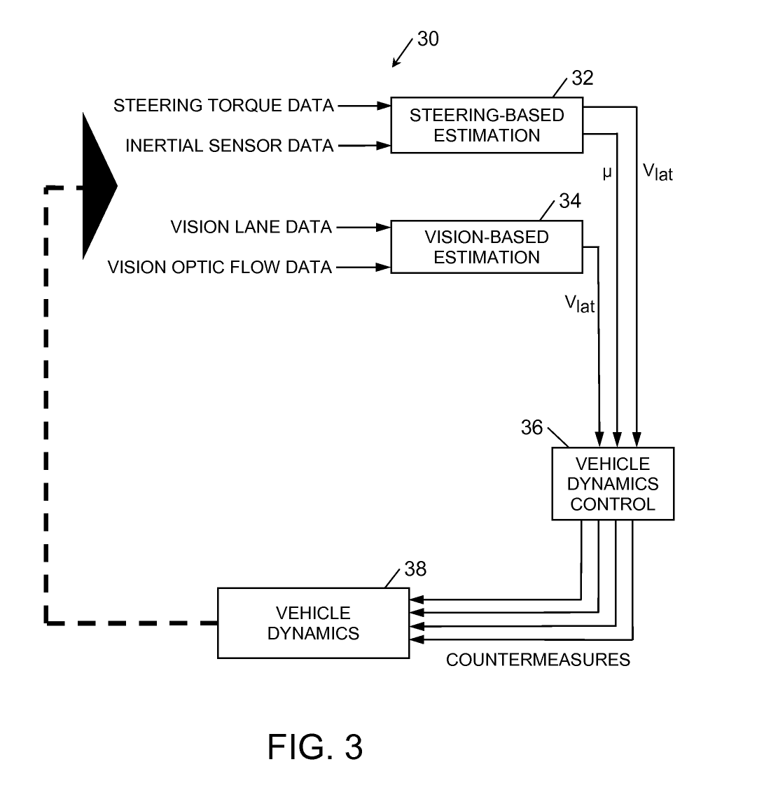

FIG. 3 shows a block diagram of a simplified exemplary embodiment of a vehicle dynamics control system 30 in accordance with the invention. The vehicle dynamics control system 30 includes a steering-based estimation 32 which works in accordance with the concepts described above, namely by using steering torque data indicative of forces acting on the tires and inertial sensor data. The steering-based estimation 32 calculates the friction coefficient μ and/or the lateral velocity Vₗₐₜ as a function of the steering torque data and/or the inertial sensor data.

The vehicle dynamics control system 30 further includes a vision-based estimation 34 which calculates the lateral velocity Vₗₐₜ as a function of image data acquired by a vehicle-mounted camera. A vehicle dynamics control 36 receives information from the steering-based estimation 32 and from the vision-based estimation 34. The vehicle dynamics control 36 triggers countermeasures in order to control vehicle dynamics 38.

The vehicle dynamics control system 30 shown in FIG. 3 operates such that steering torque data, inertial sensor data, vision lane data, and vision optic flow data are acquired in accordance with the methods described above. The steering torque data may for example be acquired by measuring a torque with a torque sensor in the steering column of the vehicle, by measuring a torque applied across a power steering unit, by measuring a force in a steering tie-rod or by measuring forces with sensors that are integrated in the tires of the vehicle.

The inertial sensor data are for example acquired with acceleration sensors that measure accelerations in a longitudinal direction, a vertical direction and a lateral direction. Inertial data can also be provided by a gyro that is used to measure a yaw rate. Vision lane data and vision optic flow data are provided by a vehicle-mounted camera 44 that captures images of the road. The steering-based estimation 32 and the vision-based estimation 34 process the steering torque data, the inertial sensor data, and the image data and provide an estimation of the friction coefficient μ as well as an estimation of the lateral velocity Vₗₐₜ of the vehicle.

The lateral velocity Vₗₐₜ and the friction coefficient μ together with other data such as the steering angle δ, the longitudinal velocity V of the vehicle, engine sensor information, transmission sensor information and brake pressure information are used to determine a current vehicle state. Based on the current vehicle state specific countermeasures are triggered in order to influence the vehicle dynamics 38. The various countermeasures include for example reducing the output of the engine, increasing or decreasing a break pressure for a given one of the wheels, increasing or decreasing a drive torque for a driven wheel or a driven axle, decreasing or increasing a steering torque assist, adjusting a steering angle and controlling components of an active suspension. As a result of these countermeasures, an excessive sliding of the tires, an excessive yaw motion, a rollover and any other vehicle instability can be reduced or prevented.

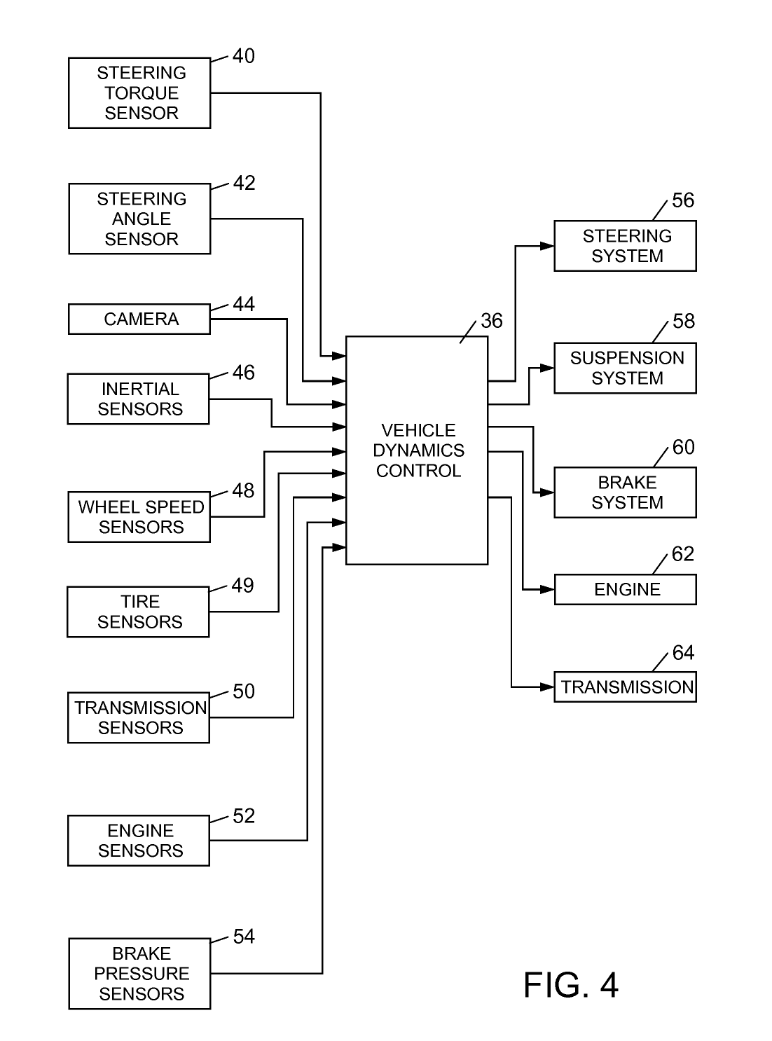

FIG. 4 is a block diagram illustrating components of an exemplary embodiment of a vehicle dynamics control system in accordance with the invention. The vehicle dynamics control 36 is configured to receive information from a steering torque sensor 40 and a steering angle sensor 42. In addition or as an alternative to the steering torque sensor 40, tire sensors 49 may be provided. The tire sensors 49 are sensors that are integrated into the tires for measuring forces acting on the tires. The measured forces allow a determination of a steering torque or aligning torque. A camera 44, which may for example be the rear-view camera or backup camera of the vehicle, provides image information by capturing images of the road. One or more inertial sensors 46, which measure accelerations and/or angular rates, provide inertial sensor data for the vehicle dynamics control 36. Wheel speed sensors 48 determine a rotational speed of the wheels. Transmission sensors 50 provide information related to the transmission such as gear stage information and gear engagement information. Engine sensors 52 provide information related to the engine, such as the engine speed, the throttle position, the ignition timing and fuel injection information. Brake pressure sensors 54 provide information about brake actuation.

The vehicle dynamics control 36 controls the steering system 56 such that the power assist or torque assist is decreased or increased and, in the case of an active steering system, such that the steering angle is adjusted. The suspension system 58 is also controlled by the vehicle dynamics control 36. The level of control depends on whether the suspension system 58 is a full-active suspension or a semi-active suspension and whether the suspension has active roll bars. The brake system 60 is controlled in the manner described above. For example, differential breaking can be used to introduce a yaw moment. The engine 62 can be controlled in order to decrease or increase the output of the engine 62. The vehicle dynamics control 36 also controls the transmission 64, for example by disengaging or engaging gears.

What is claimed is:

1. A method for controlling vehicle dynamics, which comprises:
acquiring steering torque data indicative of forces acting on at least one tire of a vehicle;
acquiring image data by capturing images of an area outside the vehicle;
determining a friction coefficient between at least one tire of the vehicle and a road surface as a function of vehicle data including at least the steering torque data;
determining a lateral velocity of the vehicle as a function of vehicle data including at least one of the steering torque data and the image data; and
performing a vehicle dynamics control as a function of at least the lateral velocity and the friction coefficient.

2. The method according to claim 1, which comprises:
acquiring the image data with a vehicle-mounted camera by capturing images of a road;
performing an image processing in order to detect lane markers provided on the road; and
determining the lateral velocity of the vehicle by evaluating a motion of the vehicle with respect to the lane markers.

3. The method according to claim 2, which comprises:
determining a lateral error of the vehicle by evaluating a motion of the vehicle with respect to the lane markers, wherein the lateral error is a distance between an imaginary lane centerline and a center of gravity of the vehicle;
determining a heading error of the vehicle by evaluating the motion of the vehicle with respect to the lane markers, wherein the heading error is a difference in angle between the imaginary lane centerline and a direction of a longitudinal axis of the vehicle;
determining a longitudinal velocity of the vehicle; and
determining the lateral velocity of the vehicle as a function of the lateral error, the heading error and the longitudinal velocity the vehicle.

4. The method according to claim 1, which comprises determining at least the lateral velocity of the vehicle with an optic flow technique by examining an apparent movement of objects in images captured by a camera and by calculating a motion of the vehicle as a function of the apparent movement of the objects in the images.

5. The method according to claim 1, which comprises using a vehicle-mounted rear-view camera in order to capture the images of the area outside the vehicle.

6. The method according to claim 1, which comprises acquiring the steering torque data by measuring a torque with a torque sensor mounted in a steering column of the vehicle.

7. The method according to claim 1, which comprises acquiring the steering torque data from torque measurements performed by a sensor measuring a torque across a power steering unit of one of an electric power steering system and a steer-by-wire steering system.

8. The method according to claim 1, which comprises acquiring the steering torque data by evaluating a torque provided by an electric motor powering an electric power steering system of the vehicle.

9. The method according to claim 1, which comprises acquiring the steering torque data by measuring a force in a steering tie-rod of a steering system of the vehicle.

10. The method according to claim 1, which comprises acquiring the steering torque data by measuring, with a sensor integrated in a tire of the vehicle, a force acting on the tire of the vehicle.

11. The method according to claim 1, which comprises:
determining a body sideslip angle of the vehicle;
performing a vehicle dynamics control by engaging a vehicle dynamics control system, if at least one of the lateral velocity and the body sideslip angle exceeds a respective threshold value; and
controlling, with the vehicle dynamics control system, at least one vehicle system selected from the group consisting of a brake system, a steering system, an engine, a transmission and a suspension system.

12. The method according to claim 1, which comprises:
determining wheel slip angles as a function of the lateral velocity of the vehicle, a longitudinal velocity of the vehicle, a distance between a center of gravity of the vehicle and a front axle of the vehicle, a distance between the center of gravity of the vehicle and a rear axle of the vehicle, a yaw rate and a steering angle;
performing a vehicle dynamics control by engaging a vehicle dynamics control system, if at least one of the wheel slip angles exceeds a respective threshold value; and
controlling, with the vehicle dynamics control system, at least one vehicle system selected from the group consisting of a brake system, a steering system, an engine, a transmission and a suspension system.

13. The method according to claim 1, which comprises:
monitoring the friction coefficient and performing a vehicle dynamics control by engaging a vehicle dynamics control system, if the friction coefficient falls below a given threshold value; and
controlling, with the vehicle dynamics control system, at least one vehicle system selected from the group consisting of a brake system, a steering system, an engine, a transmission and a suspension system.

14. The method according to claim 1, which comprises:
determining a wheel slip angle of a front wheel of the vehicle; and
performing a vehicle dynamics control by controlling a steering system of the vehicle such that a torque assist for a steering wheel of the vehicle is decreased, if the wheel slip angle of the front wheel exceeds a given threshold value.

15. The method according to claim 1, which comprises controlling a steering system of the vehicle such that a torque assist for a steering wheel of the vehicle is decreased, if the friction coefficient falls below a given threshold value.

16. The method according to claim 1, which comprises:
determining a wheel slip angle of a rear wheel of the vehicle; and
performing a vehicle dynamics control by controlling an active steering system of the vehicle such that a steering angle of a front wheel is increased, if the wheel slip angle of the rear wheel exceeds a given threshold value.

17. The method according to claim 1, which comprises:
determining a wheel slip angle of a rear wheel of the vehicle; and
performing a vehicle dynamics control by controlling an active steering system of the vehicle such that a steering angle of a front wheel is increased, if the wheel slip angle of the rear wheel exceeds a given threshold value and the friction coefficient falls below a given threshold value.

18. The method according to claim 1, which comprises:
acquiring inertial sensor data indicative of a motion of the vehicle; and
determining the lateral velocity of the vehicle as a function of vehicle data including at least the inertial sensor data.
